(19) United States
(12) Patent Application Publication
(10) Pub. No.: US 2025/0146863 A1
(43) Pub. Date: May 8, 2025

(54) LINEAR ACOUSTIC SENSING WITH A FLEXIBLE ARRAY

(71) Applicant: NEC Laboratories America, Inc., Princeton, NJ (US)

(72) Inventors: Jian Fang, Princeton, NJ (US); Wataru Kohno, Princeton, NJ (US); Ting Wang, West Windsor, NJ (US)

(21) Appl. No.: 18/930,454

(22) Filed: Oct. 29, 2024

Related U.S. Application Data
(60) Provisional application No. 63/595,793, filed on Nov. 3, 2023.
(60) Provisional application No. 63/595,887, filed on Nov. 3, 2023.

(51) Int. Cl. G01H 9/00

(52) U.S. Cl. CPC G01H 9/004

(57) ABSTRACT

Methods and systems for acoustic sensing include determining sensing locations along a fiber to generate a beam pattern that is directed to an acoustic source. An optical pulse is transmitted on the fiber. Optical phase of backscattering light is measured from the sensing locations on the fiber. An output signal is generated by combining the measured optical phase according to the beam pattern.

### RELATED APPLICATION INFORMATION

This application claims priority to U.S. Patent Application No. 63/595,793, filed on Nov. 3, 2023, and to U.S. Patent Application No. 63/595,887, filed on Nov. 3, 2023, each incorporated herein by reference in its entirety.

### BACKGROUND

### Technical Field

The present invention relates to acoustic sensing and, more particularly, to distributed acoustic sensing with fiber.

### Description of the Related Art

Acoustic sensing can be performed using an acoustic array, where multiple sensors are arranged in a predetermined configuration. As an acoustic signal passes by the sensors, the relative phases of the received signal at the different sensors can be compared to localize the source of the acoustic signal. Additionally, a phase shift can be applied to the signal received from each sensor and the output signals may be combined, so that interference between the output signals can create directionality. With this directionality, acoustic signals from a particular dimension can be sensed to the exclusion of acoustic signals from other directions.

### SUMMARY

A method for acoustic sensing includes determining sensing locations along a fiber to generate a beam pattern that is directed to an acoustic source. An optical pulse is transmitted on the fiber. Optical phase of backscattering light is measured from the sensing locations on the fiber. An output signal is generated by combining the measured optical phase according to the beam pattern.

A system for acoustic sensing includes a hardware processor and a memory that stores a computer program. When executed by the hardware processor, the computer program causes the hardware processor to determine sensing locations along a fiber to generate a beam pattern that is directed to an acoustic source, to trigger transmission of an optical pulse on the fiber, to measure optical phase of backscattering light from the sensing locations on the fiber, and to generate an output signal by combining the measured optical phase of backscattering light at selected fiber locations according to the beam pattern.

An acoustic sensing system includes a light source, an optical detector, a hardware processor, and a memory that stores a computer program. When executed by the hardware processor, the computer program causes the hardware processor to determine sensing locations along a fiber to generate a beam pattern that is directed to an acoustic source, to trigger transmission of an optical pulse on the fiber using the light source, to measure optical phase from the sensing locations on the fiber using the optical detector, and to generate an output signal by combining the measured optical phases according to the beam pattern.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram of an acoustic sensing system that uses an optical fiber as a sensor, in accordance with an embodiment of the present invention;

FIG. 2 is a block diagram of a distributed acoustic sensing system that uses optical pulses along a fiber to measure acoustic conditions at multiple positions along the fiber, in accordance with an embodiment of the present invention;

FIG. 3 is a block diagram of a controller for a distributed acoustic sensing system, in accordance with an embodiment of the present invention;

FIG. 4 is a block/flow diagram of a method for selecting an acoustic beamforming direction using an optical fiber, in accordance with an embodiment of the present invention;

FIG. 5 is a block/flow diagram of a method for acoustic beamforming using an optical fiber, in accordance with an embodiment of the present invention; and

FIG. 6 is a block diagram of a computing device that can perform acoustic sensing on an optical fiber, in accordance with an embodiment of the present invention.

### DETAILED DESCRIPTION OF PREFERRED EMBODIMENTS

An optical fiber can be used as a series of acoustic sensors. As will be described in greater detail below, an acoustic signal will cause perturbations in the physical properties of the fiber. As an optical signal passes through the fiber, these perturbations cause phase change of the reflected light. Thus, an optical pulse may be sent down the fiber and the phase change from reflected light can be measured to identify how the acoustic signal affects the fiber. Each segment of the fiber reacts to the acoustic signal independently, and creates its own reflections. Thus a single fiber can act as a linear array of acoustic sensors.

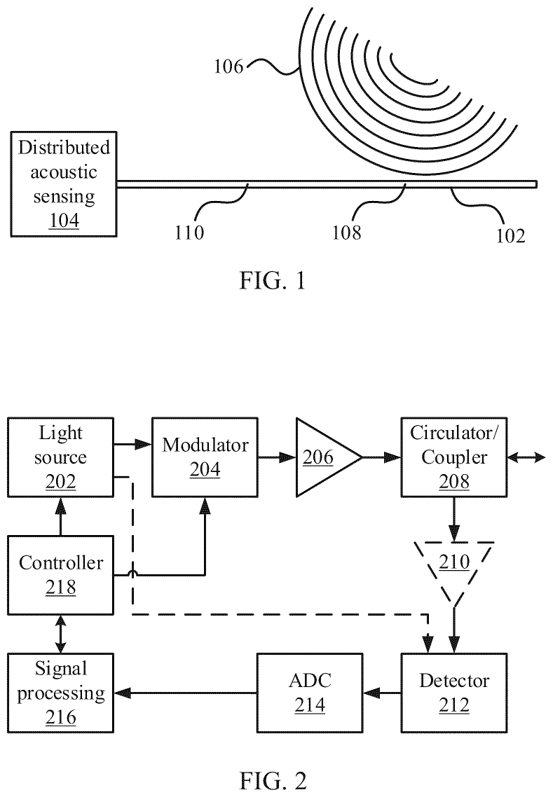

Referring now to FIG. 1, an exemplary acoustic sensor system is shown. A single optical fiber 102 is illustrated, with a distributed acoustic sensing system 104 at one end. An acoustic signal 106 is generated by a sound occurring in the vicinity of the fiber 102. As the acoustic signal 106 propagates through the surrounding medium (e.g., air), it impact the fiber 102 at different times along its length, due to the finite speed of sound through the medium. Thus, portions of the fiber 102 that are closer to the source of the acoustic signal 106 will be affected by the acoustic signal 106 sooner than portions of the fiber 102 that are farther away.

The fiber 102 may be any appropriate fiber-optic cable, such as a single-mode, few-mode, multimode, or other type of specialty cable. The fiber 102 acts as a continuous sensing element, with each section acting as a small sensor that can detect acoustic waves along its length. The fiber 102 can be wrapped in an elastic support material to increase the sensitivity and reduce the dimension, such as being wrapped around thin-wall hollow cylindrical transducers or being attached to the surface of an elastic cable.

Each point on the fiber 102 may be treated as if it were a separate microphone in an array. As an optical pulse from the distributed acoustic sensing system 104 travels along the length of the fiber 102, in this example from left to right, variations in the properties of the fiber 102 will cause optical phase change on the reflected or backscattered light from the optical pulse to bounce back to the distributed acoustic sensing system 104. The point along the fiber 102 from which the reflection originates can be determined based on the speed of light within the fiber, measured from the time the optical pulse leaves the distributed acoustic sensing system 104 to the time the reflection is received.

These optical phase changes of reflected or backscattered light from certain locations are signals that can be combined to form a beam of sensitivity that focuses on a specific direction relative to the fiber 102. This direction can be selected by changing the relative phases of the combined signals and by the position of the sensing location. The positions can be selected as above, by selecting the optical phase signal at particular fiber distance that arrive at the distributed acoustic sensing system 104 at a predetermined time based on their distance from the distributed acoustic sensing system 104 along the length of the fiber 102. For example, sensing locations 108 and 110 will generate different optical phase change that can be differentiated from one another based on the time of arrival of those sensing locations from the emission of a given optical pulse.

The effective aperture of each sensing location is determined by the center position l of the sensing location, the gauge length g of phase differentiation, and the compressed ratio between the fiber length and the geometry dimension. When using an optical pulse to interrogate the fiber 102, the optical pulse width should be no longer than the length gauge length. The gauge length also affects the signal-to-noise ratio (SNR) of the demodulated phase. Thus the longer the gauge length, the higher the SNR. However, increasing the gauge length also enlarges the sensor aperture, such that there is a trade-off between SNR and sensor aperture.

Assigning the sensing locations helps to reduce or eliminate sidelobes and grating lobes in the acoustic beam pattern. In a uniform linear array with N sensing locations, the number of sensors N and the spacing d between them determines the beamforming capabilities of the distributed acoustic sensing system 104. The spacings are related to the detection bandwidth of the array. When array size is limited (e.g., having few sensing locations), the main lobe of the beam pattern may be relatively wide, causing it to collect noise from undesirable directions. When the sensing locations have a large spacing d, the main lobe of the beam pattern may be narrow, with better directivity, but grating lobes may be present which generate undesirable directional responses.

In contrast to acoustic sensing that is performed using an array of discrete acoustic sensors, such as microphones, the distributed acoustic sensing system 104 can reconfigure the positions of the sensing locations simply by selecting new sensing locations of the fiber. Thus sensing locations can be set to any arbitrary positions along the length of the fiber 102 simply by changing the measurements at the endpoint. Sensing using optical fiber has further advantages over the use of microphones, for example in its resistance to electromagnetic interference, long sensing range, high spatial resolution, and low maintenance needs.

The distributed acoustic sensing system 104 therefore adaptively selects sensing locations in the appropriate number and separation to achieve arbitrary beamforming configurations, providing flexible null steering to reject interference even from moving sources. In addition, multiple arrays of different configurations can be superposed on a single fiber 102 at the same time, taking advantage of the properties of the different arrays and avoiding their limitations, making it possible to implement multiple beam patterns at once, providing super-directivity that minimizes the mutual coupling of the superposed arrays to achieve higher beamforming gains. Massive sub-arrays are also supported over a long sensing fiber, which provides software-defined flexible synchronized sensing that adjusts the configuration of network nodes simultaneously, which can be used in diverse applications such as defense, virtual reality, live performances, and smart factories.

Although the present embodiments are described with respect to a single fiber 102, it should be understood that multiple such fibers can be connected to a distributed acoustic sensing system 104 with the use of, e.g., an optical switch or wave division multiplexing. The different reflected signals from the different fibers can then be processed independently to provide acoustic sensing in multiple locations.

Referring now to FIG. 2, an exemplary distributed acoustic sensing system is shown. This system makes use of scattering-based acoustic detection, but it should be understood that alternative systems are also contemplated, such as those which use forwarding. A light source 202 (e.g., a laser) generates an optical pulse. The optical pulse is modulated by modulator 204 and is amplified by optical amplifier 206 before being launched on the fiber 102 using circulator/coupler 208.

Backscattered optical signals from the fiber 102 are directed by the circulator/coupler 208, optionally through an optical amplifier 210, to detector 212. The detector 212 may make use of a local oscillator signal from the light source 202 to aid in equalization. The detector 212 converts the received signal from the optical domain to the electrical domain, generating an analog electrical signal that is converted to digital by analog-to-digital converter (ADC) 214. Signal processing 216 receives the digital signal, which may include multiple reflections over time, and uses that information to localize an acoustic event. The signal processing 216 may further provide feedback to a controller 218, which can set parameters for the light source 202 and the modulator 204 for future sensing.

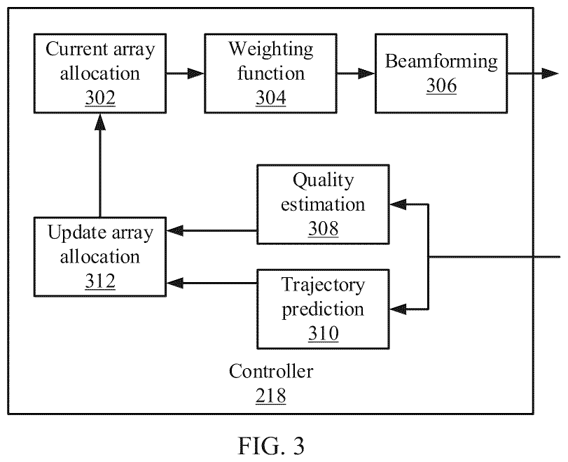

Referring now to FIG. 3, additional detail on the controller 218 is shown. A current array allocation A 302 is used to determine a beam pattern, for which particular weighting parameters are determined by weighting function 304. Beamforming 306 sets a beamforming output B(t) that is used by the signal processing 216 to localize an acoustic source.

When configuring a sensing array, the controller 218 may initialize a sensing array configuration A with N channels (A=[a₁, . . . , a_{N}], where aᵢ=[lᵢ,gᵢ]^{T} includes the i^{th} sensor's location lᵢ and corresponding gauge length gᵢ. Such an array configuration aims to detect a source S through a beamforming function h_{θ}, such as by delay-and-sum, smallest variance distortionless response, linearly constrained minimum variance, etc. The output of the beamforming function steers the response by applying the beamforming function to the data stream R received from the fiber sensing channels:

B(t)=h_{θ}^{T}R(A)

when delay-and-sum is applied. A weighting function may be applied to the selected channels, which depends on the practical cases.

When conditions change, such as when the source S moves to a different location relative to the fiber 102, then the current array configuration A may be unsuitable for detecting it. The quality of the beamforming output can be monitored through quality estimation 308, and the next possible state of the source may be predicted using trajectory prediction 310 using historical data. Once the system identifies that the current array allocation cannot provide sufficient information, or the source has moved beyond the current beam coverage, then block 312 updates the array allocation according to the outputs of the quality estimation 308 and the trajectory prediction 310. The current array allocation 302 is then updated to new channel locations A′=[a′₁, . . . , a′_{N′}], where N′ is the updated number of selected channels and aᵢ′[lᵢ′,gᵢ′]^{T} is the updated sensor location and gauge length.

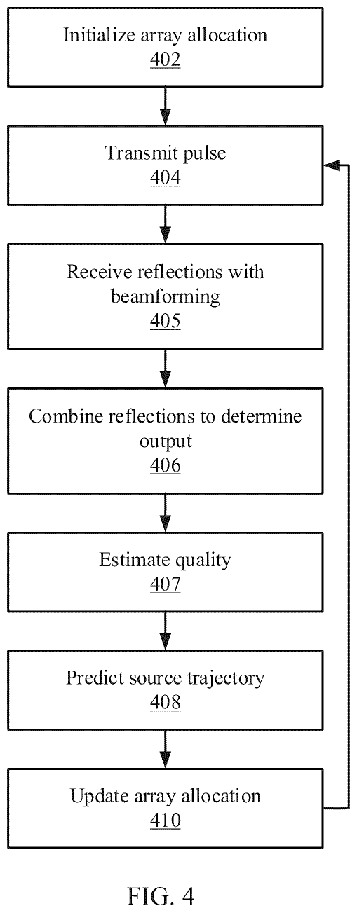

Referring now to FIG. 4, a method for adjusting the beamforming direction is shown. Block 402 begins by initializing the array allocation A and block 404 transmits an optical pulse. Block 405 receives the optical phase signal on the backscattering light on selected locations from the fiber 102 using the beamforming function defined by the array allocation, which block 406 uses to estimate quality and block 408 uses to predict a trajectory of the acoustic source. Based on this feedback, block 410 updates the array allocation to reflect any changes in circumstances, and block 404 transmits the next pulse.

Based on flexible array allocation, it is possible to perform flexible null steering in block 410. Null points on a beamforming pattern occur due to the relationship between spatial-sampling patterns and signal wavelengths. Flexible null steering makes a null point on a beamforming pattern for the target signal by proactively choosing optimized channel selections. A virtual array may be allocated with beam pattern B(θ;A), which has the main lobe targeting to θₘₐᵢₙ and some null points θₙᵤₗₗ with minimal gain. The exact angle of a null point is related to the array configuration and the main lobe direction. When conditions change, for example due to strong interference coming from a direction θᵢₙₜ contaminating the targeted signal, block 410 may adjust the array configuration to ensure that there is a null point at θᵢₙₜ:B(θᵢₙₜ;A)→0. When the interference comes from a moving source, the null points can be tracked by continuously adjusting the array allocation.

Multiple virtual arrays, each with its own respective array allocation Aₘ, may be superposed. Because the beam pattern is imposed on the received data, a given received signal may be processed according to multiple such beam patterns to provide multiple simultaneous beam patterns for a single transmitted pulse. Thus, if three sources are being tracked, S₁, S₂, and S₃, there may be three respective array configurations A₁, A₂, and A₃. In the beam forming processing, all the virtual arrays may be processed jointly to reduce noise and improve SNR. As above, quality estimation 308 and trajectory prediction 310 may be used to monitor the performance of the joint beamforming output, while updating the virtual array configurations jointly as needed. It should be noted that the virtual arrays need not be limited to uniform linear arrays, but can also include non-linear arrays such as a co-prime array, a Kronecker array, a nested array, etc.

Superposition of virtual arrays can provide flexible super-directivity, minimizing the mutual coupling among the superposed virtual arrays and providing higher beamforming gains. The joint beamforming pattern may thus be a combination of all the beam patterns, which can narrow the main lobe through product processing. Since the sidelobes and grating lobes at each beam pattern are different, combining them can help to reduce the overall levels of these unwanted lobs. This can also be used to produce a super-null by aligning the null points of different virtual arrays together, which provides stronger rejection when the interference is very strong or the SNR of the targeted source is very weak.

The signal that is received represents complex optical fields of backscattering light, having both amplitude and phase information. Additionally, the amplitude of these signals suffers from fading issues, such as Rayleigh fading. The SNR of the demodulated phase may further depend on the amplitude. Since the amount of Rayleigh scattering varies randomly over time, the phase SNR may similarly vary, which can lead to inconsistent measurements.

To address this, the complex optical field from the acoustic sensing channels can be synthesized and then the phase information can be demodulated. This guarantees fading-free beamforming that eliminates artifacts in the beamforming output and maintains a stable noise feature for reliable measurement.

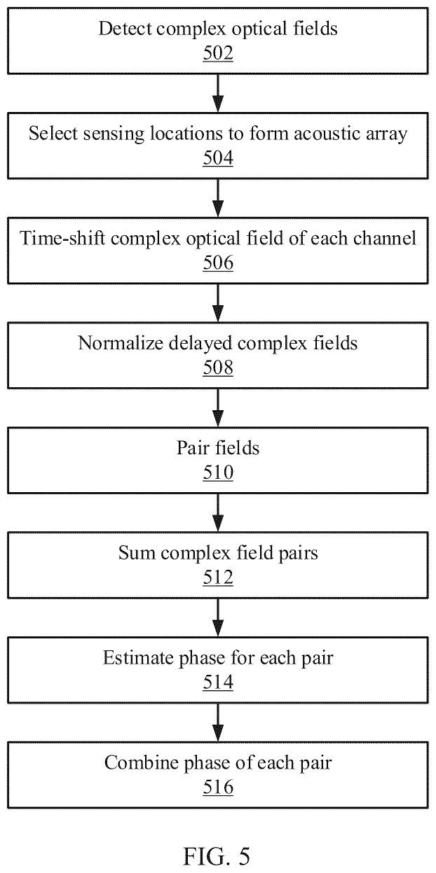

Referring now to FIG. 5, a method for beamforming is shown. Block 502 detects the complex optical fields from backscattering light along a fiber under test. Block 504 selects sensing locations along the fiber 102 as independent sensor channels to form the acoustic array, as described above. Block 506 time-shifts the complex optical field of each channel, shifting the complex optical field of each selected channel by a corresponding time delay difference that depends on the steering direction of the beam or a focus point.

Block 508 normalizes the delayed complex fields and block 510 pairs them together according to an amplitude and selection rule. Block 512 sums the complex field pairs and block 514 estimates a phase for each pair. Block 516 then combines the phase of each pair as a beamforming output.

In coherent distributed acoustic sensing, the optical field of backscattering light is recovered to the baseband. This information may be structured as a temporal-spatial complex-valued matrix as s(t,l)=A(t,l)e^{j′ϕ(t,l)}+n(t,l), where t is the time and l represents the fiber location. The noise n(t,l)=nₗ(t,l)+jn_{Q}(t,l) can be modeled as a complex random variable. In most cases, the noise is dominated by thermal noise and it is reasonable to assume that n˜ [symbol] _{C}(0,σₙ²) is Gaussian. The amplitude A is a Rayleigh-distributed spatial random process and its variance [symbol] A² [symbol] is proportional to the mean backscattering power. The dynamic SNR at time t and fiber location l can be evaluated as SNR(t,l)=σₙ²/A²(t,l).

Demodulation of the phase may be expressed as ϕ(t,l)=∠(s(t,l)). The calculation of the phase differential over a spatial gauge length is expressed as l_{G}. Phase demodulation may further include phase unwrapping. After this processing, a detected phase signal ϕ_{d}(t,l) is generated as a measurement at the time t and location l on the fiber 102.

In coherent distributed acoustic sensing, the differential phase over a gauge length l_{G} can be calculated as:

$${ϕ}_{d} ( t , l ) = unwrap ( ∠ s ( t , l + \frac{{l}_{g}}{2} ) - ∠ s ( t , l - \frac{{l}_{g}}{2} ) )$$

where the amplitudes of

$$s ( t , l + \frac{{l}_{g}}{2} ) and s ( t , l - \frac{{l}_{g}}{2} )$$

are independent random variables following the Rayleigh distribution. An alternative way is to compute

$${ϕ}_{d} ( t , l ) = unwrap ( ∠ {s}_{d} ( t , l ) )$$

where s_{d}(t,l)≡s*(t,l−l_{g}/2)s(t,l+l_{G}/2). The second form appears simpler and more precise, but Monte-Carlo simulation shows that the second form has slightly lower demodulation phase noise variance. The second form is thus used to represent differential phase. The amplitude A_{d} of the complex product s_{D} does not follow a Rayleigh distribution, but a modified Bessel function of the second kind and zero order, e.g., K₀(x).

As described above, the selection 504 of sensing locations [lᵢ, . . . , l_{N}] as N sensors obtains the N phase signals as ϕᵢ≡ϕ_{d}(t,lᵢ) for i∈{1, . . . , N}. The signals are combined via beamforming, for example using delay-and-sum, to compensate for relative temporal delay from time-of-arrival. For a far-field acoustic source which emits acoustic waves at an angle θ to each selected channel, the corresponding time delay between channels can be assigned as τᵢ. The synthesized beamforming signal will then be:

$${ϕ}_{DS} ( t ) = {\sum }_{i = 1}^{N} {w}_{i} {ϕ}_{i} ( t + {τ}_{i} )$$

where wᵢ is an optional weighting factor. Equal-gain combination can be used to assign weighting factors to wᵢ=1/N, which provides an efficient combination.

As noted above, Rayleigh fading is a common phenomenon in single-mode fibers and originates from multi-path interference among Rayleigh scatterers in the fiber. When fading occurs, the intensity of backscattering light will be reduced, and may drop to zero in some cases of destructive interference. The demodulated phase at the fading point will fail with large noise.

The optical fields may be expressed as sᵢ(t)=s_{d}(t,lᵢ)=Aᵢe^{jϕ}^{₁}^{(t)}, where Aᵢ(t)≡A_{d}(t,lᵢ) and ϕᵢ(t)≡ϕ_{d}(t,lᵢ). The acoustic signals from the sound source are included in the phase part, while the amplitude part is from the Rayleigh backscattering in optical fiber. The complex fields of the channels are combined first and the phase may then be demodulated to achieve beamforming in three-dimensional space while suppressing the noise and failure from optical signals, such as fading. For two unit complex numbers, such as z₁=e^{jϕ}^{₁} and z₂=e^{j}^{₂}, the angle of their sum is the average of their phases: ∠(z₁+z₂)=½(ϕ₁+ϕ₂). Therefore the N channels can be separated into many pairs for complex field combination.

The complex fields are temporally shifted in block 506 by the time delays τᵢ which correspond to a targeted beamforming direction θ or a focus point in space. The temporal shift can be implemented either in the time domain or in the frequency domain. In the time domain, the complex field signal sᵢ(t) can be separated into real and imaginary parts, up-sampled by a factor of Q, shifted by corresponding samples, and down-sampled by Q. The up-sampling can be replaced by interpolation. Then the real and imaginary parts are combined as the delayed complex signal s(t+τᵢ). In the frequency domain, the complex fields can be transformed into a Fourier domain as Sᵢ(f) and then multiplied with a phase shift of e^{j2πfτ}^{ᵢ}. The delayed field sᵢ(t+τᵢ) can be obtained by the inverse Fourier transform of Sᵢ(f)e^{j2πfτ}^{ᵢ}.

These delayed complex fields may be normalized in block 508 according to their estimated amplitude Âᵢ as zᵢ(t+τᵢ). The normalized fields are sorted and paired into N/2 pairs in block 510 according to a rule. For example, the fields may be sorted according to their estimated amplitudes in descending order as Âₖ≥Âₖ_{₂}≥Âₖ_{_{N}}, where Aₖ_{ₘ}≡|Sₖ_{ₘ}(t+τₖ_{ₘ})| for kₘ∈{1, . . . , N}/ The fields can be combined into N/2 pairs such as [Âₖ_{₁},Âₖ_{_{N}}], [Âₖ_{₂},Âₖ_{_{N−1}}], . . . [Âₖ_{_{N/2}},Âₖ_{_{N/2+1}}]. A threshold for the estimated amplitudes may be set to discard those fields with small or near-zero amplitudes. Other pairing or selection rules may also be applied. Thus the number of field pairs may be M≤N/2.

Block 514 estimates the phases. Since the small-amplitude field has been combined with the large-amplitude field by pairing, the estimated phase error will be significantly mitigated. Block 516 combines the normalized complex field pairs together to obtain the beamforming output.

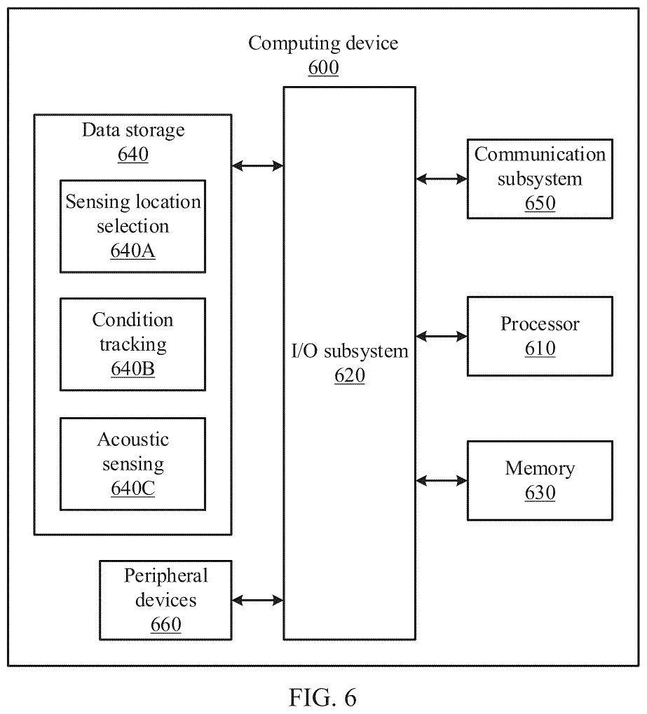

Referring now to FIG. 6, an exemplary computing device 600 is shown, in accordance with an embodiment of the present invention. The computing device 600 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 600 may be embodied as one or more compute sleds, memory sleds, or other racks, sleds, computing chassis, or other components of a physically disaggregated computing device.

As shown in FIG. 6, the computing device 600 illustratively includes the processor 610, an input/output subsystem 620, a memory 630, a data storage device 640, and a communication subsystem 650, and/or other components and devices commonly found in a server or similar computing device. The computing device 600 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 630, or portions thereof, may be incorporated in the processor 610 in some embodiments.

The processor 610 may be embodied as any type of processor capable of performing the functions described herein. The processor 610 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 630 may be embodied as any type of volatile or non-volatile memory or data storage capable of performing the functions described herein. In operation, the memory 630 may store various data and software used during operation of the computing device 600, such as operating systems, applications, programs, libraries, and drivers. The memory 630 is communicatively coupled to the processor 610 via the I/O subsystem 620, which may be embodied as circuitry and/or components to facilitate input/output operations with the processor 610, the memory 630, and other components of the computing device 600. For example, the I/O subsystem 620 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 620 may form a portion of a system-on-a-chip (SOC) and be incorporated, along with the processor 610, the memory 630, and other components of the computing device 600, on a single integrated circuit chip.

The data storage device 640 may be embodied as any type of device or devices configured for short-term or long-term storage of data such as, for example, memory devices and circuits, memory cards, hard disk drives, solid state drives, or other data storage devices. The data storage device 640 can store program code 640A for selecting sensing locations, 640B for tracking changing conditions, and/or 640C for performing acoustic sensing. Any or all of these program code blocks may be included in a given computing system. The communication subsystem 650 of the computing device 600 may be embodied as any network interface controller or other communication circuit, device, or collection thereof, capable of enabling communications between the computing device 600 and other remote devices over a network. The communication subsystem 650 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 600 may also include one or more peripheral devices 660. The peripheral devices 660 may include any number of additional input/output devices, interface devices, and/or other peripheral devices. For example, in some embodiments, the peripheral devices 660 may include a display, touch screen, graphics circuitry, keyboard, mouse, speaker system, microphone, network interface, and/or other input/output devices, interface devices, and/or peripheral devices.

Of course, the computing device 600 may also include other elements (not shown), as readily contemplated by one of skill in the art, as well as omit certain elements. For example, various other sensors, input devices, and/or output devices can be included in computing device 600, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 600 are readily contemplated by one of ordinary skill in the art given the teachings of the present invention provided herein.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for acoustic sensing, comprising:
determining sensing locations along a fiber to generate a beam pattern that is directed to an acoustic source;
transmitting an optical pulse on the fiber;
measuring optical phase of backscattering light from the sensing locations on the fiber; and
generating an output signal by combining the measured optical phase according to the beam pattern.

2. The method of claim 1, further comprising updating the sensing locations in accordance with changing conditions.

3. The method of claim 2, wherein updating the sensing locations includes estimating quality of the output signal.

4. The method of claim 2, wherein updating the sensing locations includes predicting a trajectory of a source.

5. The method of claim 1, generating the output signal includes pairing complex fields of the measured optical phase of backscattering light according to amplitude and estimating phase for respective pairs of complex fields.

6. The method of claim 5, further comprising combining the phases of the pairs of complex fields as the output.

7. The method of claim 5, wherein pairing the complex fields combines complex fields of progressively increasing amplitude with corresponding complex fields of progressively decreasing amplitude.

8. The method of claim 1, wherein determining the sensing locations includes generating distinct sets of sensing locations for multiple respective beam patterns.

9. The method of claim 8, wherein generating the output signal includes combining outputs from the distinct sets of sensing locations to combine the multiple beam patterns.

10. The method of claim 8, wherein determining the sensing locations includes determining sensing locations along multiple distinct fibers, transmitting the optical pulse includes transmitting optical pulses along the multiple distinct fibers, measuring optical phase of backscattering light includes measuring optical phase from the multiple distinct fibers, and generating the output signal includes combining the measured optical phase according to the multiple beam patterns.

11. A system for acoustic sensing, comprising:
a hardware processor; and
a memory that stores a computer program which, when executed by the hardware processor, cause the hardware processor to:
determine sensing locations along a fiber to generate a beam pattern that is directed to an acoustic source;
trigger transmission of an optical pulse on the fiber;
measure optical phase of backscattering light from the sensing locations on the fiber; and
generate an output signal by combining the measured optical phase of backscattering light at selected fiber locations according to the beam pattern.

12. The system of claim 11, further comprising updating the sensing locations in accordance with changing conditions.

13. The system of claim 12, wherein updating the sensing locations includes estimating quality of the output signal.

14. The system of claim 12, wherein updating the sensing locations includes predicting a trajectory of a source.

15. The system of claim 11, generating the output signal includes pairing complex fields of the measured optical phase according to amplitude and estimating phase for respective pairs of complex fields.

16. The system of claim 15, further comprising combining the phases of the pairs of complex fields as the output.

17. The system of claim 15, wherein pairing the complex fields combines complex fields of progressively increasing amplitude with corresponding complex fields of progressively decreasing amplitude.

18. The system of claim 11, wherein determining the sensing locations includes generating distinct sets of sensing locations for multiple respective beam patterns.

19. The system of claim 18, wherein generating the output signal includes combining outputs from the distinct sets of sensing locations to combine the multiple beam patterns.

20. An acoustic sensing system, comprising:
a light source;
an optical detector;
a hardware processor; and
a memory that stores a computer program which, when executed by the hardware processor, cause the hardware processor to:
determine sensing locations along a fiber to generate a beam pattern that is directed to an acoustic source;
trigger transmission of an optical pulse on the fiber using the light source;
measure optical phase from the sensing locations on the fiber using the optical detector; and
generate an output signal by combining the measured optical phases according to the beam pattern.
